(19) United States
(12) Patent Application Publication
(10) Pub. No.: US 2014/0224639 A1
(43) Pub. Date: Aug. 14, 2014

(54) Devolatilization/solution concentration process utilizing an auxiliary volatilizable and condensable heat transfer fluid

(71) Applicant: Chaloke Pungtrakul, Bangkok (TH)

(72) Inventor: Chaloke Pungtrakul, Bangkok (TH)

(21) Appl. No.: 13/764,790

(22) Filed: Feb. 12, 2013

(51) Int. Cl. B01D 3/00

(52) U.S. Cl. CPC B01D 3/007
USPC 203/22

(57) ABSTRACT

In a devolatilization/solution concentration process which comprises pre-heating a feed stream, providing a small amount of additional heat to the pre-heated stream, evaporating a portion of the heated stream into a gaseous medium to cool the remaining, concentrated stream, and condensing the vapor in the gaseous medium to provide the pre-heating and produce a condensed volatile matter stream, particularly when the feed stream comprises a dilute aqueous solution containing a dissolved desiccant, the temperature of the pre-heated stream can be raised by evaporating a portion of an auxiliary heat transfer fluid into a gaseous medium and condensing its vapor in the gaseous medium to provide at least another part of the pre-heating. This will reduce the amount of the additional heat which has to be supplied, improve the performance, and better adapt the process to various end-use applications.

### FIELD OF THE INVENTION

This invention relates to the process of extracting a volatilizable constituent from a solution, particularly the process of re-concentrating diluted aqueous desiccant solution by utilizing an auxiliary volatilizable and condensable heat transfer fluid.

### BACKGROUND OF THE INVENTION

U.S. patent application Ser. No. 13/442,888 has described a devolatilization/solution concentration process which comprises (a) pre-heating a feed stream, (b) providing additional heat to the pre-heated stream, (c) evaporating a portion of the heated stream into a gaseous medium to cool the remaining, concentrated stream, and (d) condensing vapor in the gaseous medium from step (c) to provide the pre-heating of the feed stream in step (a) and produce a condensed volatile matter stream, wherein at least a part of the evaporation into the gaseous medium in step (c) takes place at a temperature higher than the normal boiling point of the feed stream. Since the feed stream is pre-heated to a relatively high temperature, more heat is available for the evaporation, and since the evaporation into the gaseous medium in step (c) occurs at a temperature just slightly higher than the temperature of the pre-heated stream,less additional heat could be provided to the pre-heated stream in step (b), thus increasing the performance (the ratio between the heat of evaporation and the additional heat provided). However, when the feed stream is a dilute aqueous solution containing a dissolved desiccant, although the afore-mentioned Patent Application has anticipated that the temperature of the pre-heated stream can be raised to a point just slightly below the temperature of evaporation in step (c), it has been more concerned with the overall view, and no detail is given as to how this is actually accomplished.

FIG. 1 is a process flow diagram illustrating the basic volatile extraction/solution concentration process according to the prior art wherein feed stream 1 is fed by pump 2 through pre-heating coil 3 in condensing chamber 4 to provide pre-heated stream 5. The pre-heated stream 5 is then heated in heat exchanger 6 equipped with a heating medium inlet 7 and a heating medium outlet 8, and the heated stream 9 is sprayed trough nozzles 10 into an upper portion of evaporating chamber 11, while fan 12 circulates cooled gas 13 from a lower portion of the evaporating chamber up to the upper portion counter-currently. The heated, vapor-loaded gas 14 is then passed from an upper portion of the adjacent condensing chamber 4 down over cooling coil 3, and the cooled gas is re-circulated by fan 12. The condensed vapor collected at the bottom of the condensing chamber is withdrawn as condensed stream 15, while the cooled and concentrated stream 16 is withdrawn from the bottom of the evaporating chamber. For example, 1,900 kg/min. of 47.3% CaCl2 solution 1 at a temperature of 49.7 C may be fed by pump 2 through pre-heating coil 3 in condensing chamber 4, the pre-heated solution 5 may be heated in heat exchanger 6 to 200 C, 5.576 atm, and the heated solution 9 may be sprayed through nozzles 10 into the upper portion of the evaporating chamber 11 to heat 272.8 ft3/min. of air 13 at a temperature of 51.7 C, relative humidity of 100%, and pressure of 1.631 atm from fan 12 to 198 C, relative humidity 32.3% and evaporate 380 kg/min. of water from the solution. However, since water vapor in the heated air 14 having a relative humidity of 32.3% would not condense until a dew point of 154.8 C is reached, the temperature of the pre-heated solution 5 would be limited to about 154.8 C. Since the pre-heated solution 5 would then carry less heat, some heat (11,483,421 Btu/hr) must be transferred from the the condensing chamber to the evaporating chamber by another means as indicated by dashed arrow 17, and as much as 13,573,034 Btu/hr must be supplied to heat exchanger 6 to raise its temperature from 154.8 C to 200 C which when compared to the 50,219,680 Btu/hr required to evaporate 380 kg/min. of water, the coefficient of performance would be only 3.7.

It is thus desirable to be able to raise the temperature of the pre-heated stream to a point just slightly lower than the temperature of evaporation into the gaseous medium, in order to reduce the amount of the additional heat that has to be supplied and improve the performance to the level of 10-20 or even higher.

### SUMMARY OF THE INVENTION

Although there may be many possible ways to raise the temperature of the pre-heated stream to a point just slightly lower than the temperature of evaporation into the gaseous medium, the object of the present invention is to provide a simple and effective way to do so, thus improving the performance and better adapt the process to various end-use applications.

According to first aspect, the present invention provides a devolatilization/solution concentration process which comprises (a) pre-heating a feed stream from a 1st temperature to a 2nd temperature, (b) providing a small amount of additional heat to the pre-heated stream, (c) evaporating a portion of the heated stream into a gaseous medium to heat the gaseous medium to a 3rd temperature and cool the remaining, concentrated stream to a 4th temperature, (d) condensing the vapor in the gaseous medium from step (c) to provide at least a part of said pre-heating in step (a) and produce a condensed volatile matter stream, and (e) evaporating at least a portion of an auxiliary heat transfer fluid into a gaseous medium and condensing its vapor in the gaseous medium to provide at least another part of said pre-heating in step (a) and raise said 2nd temperature to a point just slightly lower than said 3rd temperature.

Since the vapor of the auxiliary heat transfer fluid in the gaseous medium will condense at a much higher temperature, eventhough the vapor of the volatile matter in the gaseous medium will only begin to condense at a much lower temperature, the temperature of the pre-heated stream (the 2nd temperature) would be raised to a point just slightly lower than the temperature of the heated gaseous medium (the 3rd temperature).

The above and other objects and advantages of the present invention will be more readily apparent from the Detailed Description.

### BRIEF DESCRIPTION OF THE DRAWINGS

FIG. 1 is a schematic process flow diagram illustrating the basic volatile extraction/solution concentration process according to the prior art.

FIG. 2 is a schematic process flow diagram illustrating volatile extraction/solution concentration process according to a first embodiment of the present invention wherein an auxiliary heat transfer fluid is partially vaporized into the gaseous medium and its vapor in the gaseous medium is condensed at a temperature just slightly lower than the temperature of the heated gaseous medium.

FIG. 3 is a schematic process flow diagram illustrating volatile extraction/solution concentration process according to a second embodiment of the present invention wherein the same auxiliary heat transfer fluid is also used to directly pre-heat the feed stream.

FIG. 4 is a schematic process flow diagram illustrating volatile extraction/solution concentration process according to a third embodiment of the present invention wherein the volatile matter is evaporated and condensed in one circuit, while the auxiliary heat transfer fluid is evaporated and condensed in another, separate circuit.

FIG. 5 is a schematic process flow diagram illustrating volatile extraction/solution concentration process according to a fourth embodiment of the present invention wherein the condensed auxiliary heat transfer fluid is separated off before the volatile matter begin to condense.

FIG. 6 is a schematic process flow diagram illustrating volatile extraction/solution concentration process according to a fifth embodiment of the present invention wherein the auxiliary heat transfer fluid is vaporized into the gaseous medium in only limited quantity, but is essentially used to transfer a part of the heat of condensation from the condensing chamber to the evaporating chamber.

### DETAILED DESCRIPTION OF THE INVENTION

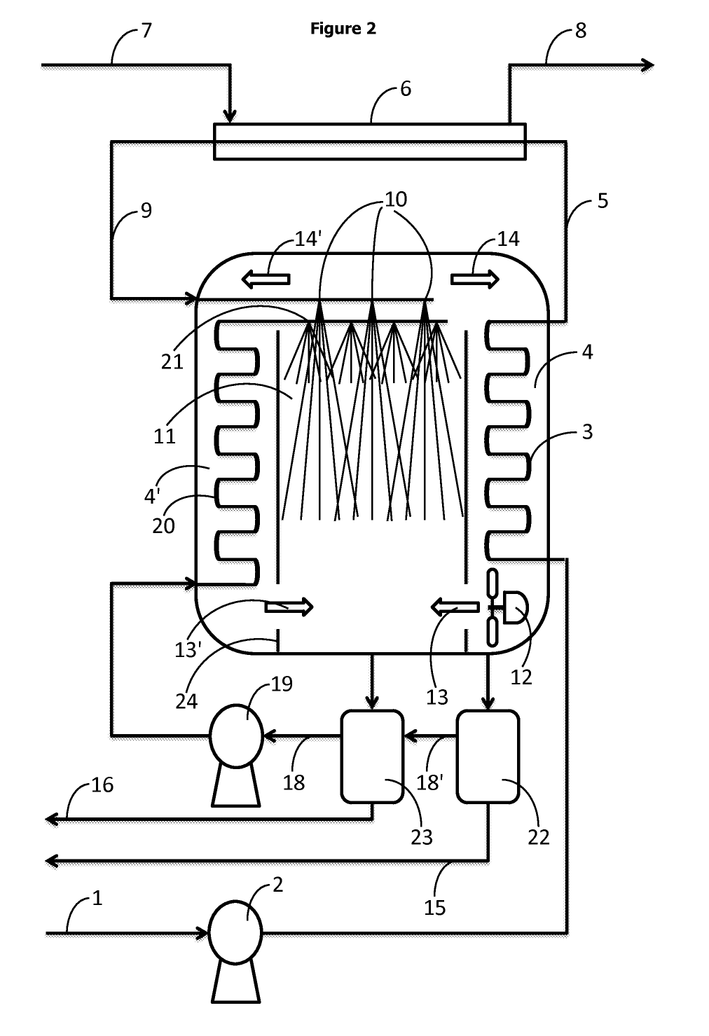

Details of the present invention will next be described with reference to FIG. 2 which depicts a first possible embodiment.

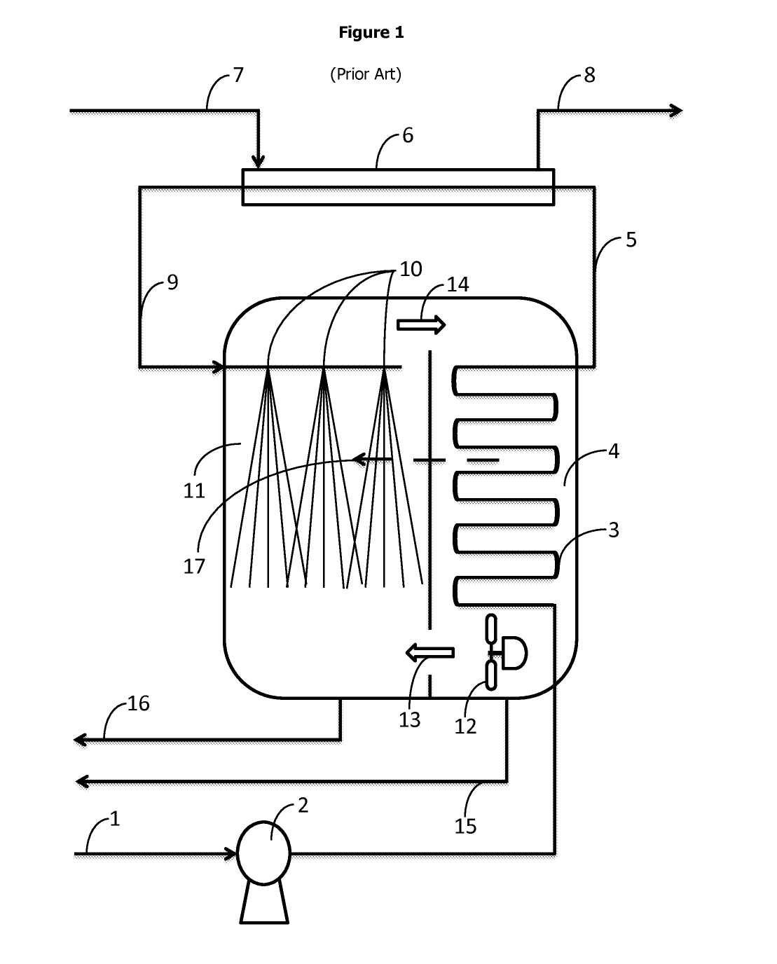

As shown in FIG. 2, feed stream 1 is fed by pump 2 through pre-heating coil 3 in condensing chamber 4 to provide a pre-heated stream 5. The pre-heated stream 5 is then heated in heat exchanger 6 equipped with heating medium inlet 7 and heating medium outlet 8, and the heated stream 9 is sprayed through nozzles 10 into upper portion of evaporating chamber 11, while fan 12 circulates cooled gas 13 from lower portion of the evaporating chamber up to the upper portion counter-currently. The heated, vapor-loaded gas 14 is then passed from upper portion of the adjacent condensing chamber 4 down over cooling coil 3, and the cooled gas is re-circulated by fan 12. The only departure from the prior art process in FIG. 1 is that an auxiliary heat transfer fluid 18 is also fed by pump 19 through heating coil 20 in condensing chamber 4′ and sprayed through nozzles 21 into the upper portion of the evaporating chamber 11, while fan 12′ (not shown) circulates cooled gas 13′ from the lower portion of the evaporating chamber up to the upper portion counter-currently. The heated, vapor-loaded gas 14′ is then passed from the upper portion of the adjacent condensing chamber 4′ down over cooling coil 20, and the cooled gas 13′ is re-circulated by fan 12′.

In actual practice, the cooled gases 13 and 13′ may be one and the same, the vapor of the volatile matter in the heated gas 14 may be intermingled with the vapor of the heat transfer fluid in the heated gas 14′, the condensing chambers 4 and 4′ may be only one annular chamber surrounding a cylindrical evaporating chamber 11, fans 12 and 12′ may comprise plurality of fans arranged in a circle around the base of the evaporating chamber, and coils 3 and 20 may be parallelly wound upward in the condensing chamber in spirals. In this case, since the vapor of the volatile matter which has condensed and the vapor of the heat transfer fluid which has condensed would accumulate together at the bottom of the condensing chamber, a separator 22 would be employed to separate the liquid from the bottom of the condensing chamber into condensed volatile matter stream 15 and heat transfer fluid stream 18′. Furthermore, since the cooled and concentrated solution would also accumulate together with the unvaporized heat transfer fluid at the bottom of the evaporating chamber 11, a separator 23 would also be employed to separate the liquid from the bottom of the evaporating chamber into concentrated stream 16 and heat transfer fluid stream 18. The heat transfer fluid stream 18′ will flow to and unite with the unvaporized heat transfer fluid in separator 23, and pump 19 will re-circulate the combined stream 18.

For example, 2,153.0 kg/min. of 47.3% CaCl2 solution 1 at a temperature of 49.7 C may be fed by pump 2 through pre-heating coil 3 in condensing chamber 4, the pre-heated solution 5 may be heated in heat exchanger 6 to 200 C, 5.576 atm, and the heated solution 9 may be sprayed through nozzles 10 into the upper portion of the evaporating chamber 11 to heat 309.1 ft3/min. of air 13 at a temperature of 51.7 C, relative humidity of 100%, and pressure of 4.033 atm from fan 12 to 198 C, relative humidity 32.3% and evaporate 430.6 kg/min. of water from the solution. Meanwhile, 5,935.7 kg/min. of ethylbenzene 18 at a temperature of 52.9 C may also be fed by pump 19 through coil 20 in condensing chamber 4′ and sprayed through nozzles 21 into the upper portion of the evaporating chamber 11. Since the partial pressure of ethylbenzene at 198 C is 4.195 atm which is comparable to the partial pressure of the water vapor under the influence of the CaCl2 solution, 2,365.4 kg/min. of ethylbenzene will evaporate into the heated air 14′ and begin to condense at 196 C, 4.033 atm. Thus, eventhough the water vapor in the heated air 14 would not condense until a dew point of 154.8 C is reached,the temperature of the solution in the pre-heating coil 3 would be brought up to 196 C, reducing the additional heat which has to be supplied to heat exchanger 6 to only 1,388,056 Btu/hr. When compared to the 56,908,565 Btu/hr required to evaporate 430.6 kg/min. of water, the coefficient of performance would be as high as 40.999.

The reason why as much as 2,365.4 kg/min. of ethylbenzene must be evaporated into the heated at 14′ is that the condensation of the vapor must not only heat the solution in the pre-heating coil 3 from 154.8 C to 196 C, which requires 13,992,804 Btu/hr, but must also heat ethylbenzene itself in the heating coil 20 from 154.8 C to 196 C, which requires a further 27,903,747 Btu/hr. Nevertheless, the 41,753,627 Btu/hr of heat necessary to evaporate the ethylbenzene would be supplied by cooling the remaining 3,570.4 kg/min. of ethylbenzene from 196 C to 53.7 C, which provides as much as 54,934,936 Btu/hr to the air 13′. It can be seen that 13,181,309 Btu/hr is still available from the cooling of the unvaporized ethylbenzene to facilitate in the evaporation of water. Since this amount of heat does not have to be carried by the pre-heated solution 5 from the condensing chamber to the evaporating chamber, its flow rate can be reduced. In other words, the use of the heat transfer fluid also renders control over the flow rate of the feed stream. In fact, according to the example just described, the flow rate of ethylbenzene has been adjusted to reduce the flow rate of the dilute solution 1 to merely 2,153.0 kg/min. Thus, when 1,722.4 kg/min. of 59.1% CaCl2 solution 16 is obtained at 53.7 C,this concentrated solution will be able to absorb 430.6 kg/min. or exactly 25% of water vapor. Furthermore, since the amount of the pre-heated solution 5 flowing through heat exchanger 6 is reduced, even if it must be heated up by more than 4 C, the performance would still be quite high.

The water vapor which has condensed and ethylbenzene vapor which has condensed will flow from the bottom of the condensing chambers 4 and 4′ into separator 22, while the concentrated solution and the unvaporized ethylbenzene will flow from the bottom of the evaporating chamber 11 into separator 23. Since ethylbenzene has a specific gravity of only 0.867, this fluid will float on water and on the concentrated solution, while only negligible amounts will be dissolved. Thus, the separators 22 and 23 may be ordinary phase separating tanks, and the condensed ethylbenzene 18′ may simply overflow from phase separating tank 22 into phase separating tank 23. Alternatively, it is also possible to dispense with separators 22 and 23 altogether and just allow the upper layer of liquid at the bottom of the evaporating chamber 11 to flow over partition 24 between the bottom of the evaporating chamber and bottom of the condensing chamber, then use pump 19 to decant the combined ethylbenzene 18 from the upper layer of liquid at the bottom of the condensing chamber.

Eventhough U.S. Pat. No. 2,411,186 (Hydrojet Corp., 1941) has described the mixing of dilute NaOH solution with “straw oil” (boiling point 277 C), the evaporation of water from the mixture under reduced pressure, the compression of the water vapor, the condensation of the compressed water vapor at a higher temperature to provide the heat for the evaporation, and the separation of the straw oil layer from the concentrated solution layer, since this Patent does not address the evaporation and condensation of the straw oil along with the evaporation and condensation of water, it can not be regarded as a prior art.

Eventhough in the embodiment shown, additional heat has been provided to the pre-heated stream 5 in heat exchange 6 externally of the evaporating chamber 11, the additional heat could also be provided to the pre-heated stream 5 internally of the evaporating chamber 11, either directly or through the heated gas 14. Eventhough in the embodiment shown, the vapor of the volatile matter in the heated gas 14 and the vapor of the heat transfer fluid in the heated gas 14′ are intermingled, it would also be possible to arrange separate circulating channels for the gaseous medium 13-14 and gaseous medium 13′-14′, and the gaseous mediums 13-14 and 13′-14′ may also be 2 different gases or 2 different mixtures of gases. For example, the gaseous medium may be a mixture of ordinary air and a hydrocarbon gas such as propane which will serve to cool the concentrated solution down upon its contact with the wet air. On the other hand, eventhough in the embodiment shown, feed stream 1 is fed by pump 2 through heating coil 3, and heat transfer fluid 18 is fed by pump 19 through heating coil 20, the feed stream 1 and the heat transfer fluid 18 could be combined and fed by a single pump through common heating coils. Furthermore, other auxiliary heat transfer fluids could be used instead of the one exemplified or even a volatilizable heat transfer fluid used together with a non-volatilizable heat transfer fluid.

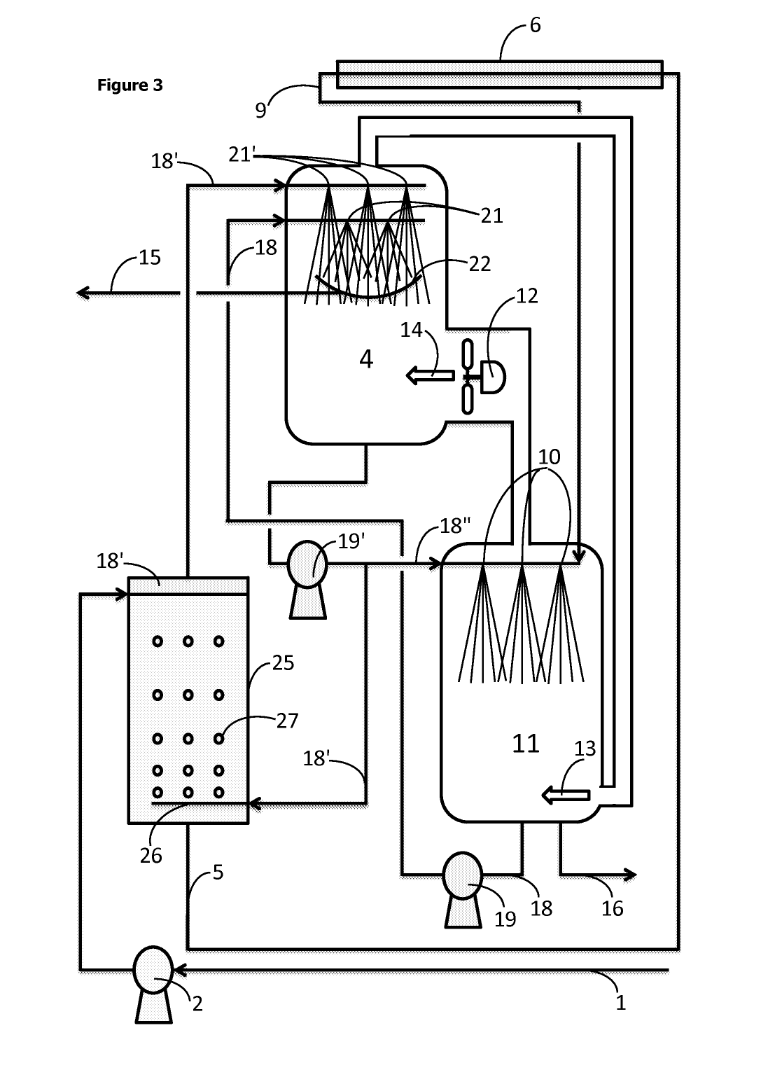

Eventhough the heating coils 3 and 20 offer simplicity in design and efficiency in operation, they could be cumbersome in construction, particularly when the pressure differential between the inside and the outside of the coils is substantial. For example, it is estimated that the heating of 2,153.0 kg/min. of CaCl2 solution 1 and 5,935.7 kg/min. of ethylbenezene 18 will require as many as 80 coils, each having a diameter of 1.5 in. and a length of 3,911 ft. FIG. 3 has shown an embodiment wherein these heating coils are eliminated.

As shown in FIG. 3, feed stream 1 is fed by pump 2 into an upper portion of a pre-heating column 25 to produce pre-heated stream 5 at the bottom of the column. The pre-heated stream 5 is then heated in heat exchanger 6 equipped with a heating medium inlet and a heating medium outlet (not shown), and the heated stream 9 is sprayed through nozzles 10 into an upper portion of an evaporating tower 11 together with heated auxiliary heat transfer fluid 18″, while fan 12 draws cooled gas 13 from a lower portion of the evaporating tower up to the upper portion counter-currently. The heated, vapor-loaded gas 14 from fan 12 is then passed from a lower portion of a condensing tower 4 up to an upper portion, while relatively cold auxiliary heat transfer fluid 18 is sprayed through nozzles 21 into the upper portion of the condensing tower and even colder auxiliary heat transfer fluid 18′ is sprayed through nozzles 21′ above the nozzles 21. Cooled gas at the top of the condensing tower 4 is re-circulated to the lower portion of the evaporating tower 11, the volatile matter which has condensed is collected in separator 22 and drawn off as condensed volatile matter stream 15, while the heated auxiliary heat transfer fluid at the bottom of the condensing tower 4 is fed by pump 19′ as stream 18′ to sparger 26 at a lower portion of the pre-heating column 25 and as stream 18″ to nozzles 10 in the upper portion of the evaporating tower 11. The auxiliary heat transfer fluid 18′ will rise from sparger 26 as globules 27, accumulate at the top of the pre-heating column 25, and re-circulate to nozzles 21′ in the upper portion of the condensing tower 4. A portion of the auxiliary heat transfer fluid 18″ issuing from nozzles 10 will evaporate into heated gas 14, and pump 19 will recirculate the unvaporized heat transfer fluid 18 from the upper layer of liquid at the bottom of the evaporating tower to nozzles 21, while the concentrated stream 16 is withdrawn from the lower layer of liquid at the bottom of the evaporating tower.

For example, 2,192.9 kg/min. of 47.3% CaCl2 solution 1 at 49.8 C may be fed by pump 2 into the upper portion of pre-heating column 25 to produce a pre-heated stream 5 having a temperature of 194 C and a pressure of 5.576 atm, which is then heated in heat exchanger 6 to 200 C. The heated stream 9 may be sprayed through nozzles 10 into the upper portion of the evaporating tower 11 together with 6,271.5 kg/min. of ethylbenzene 18″ at 196 C, while fan 12 draws 318.9 ft3/min. of air 13 at a temperature of 53.8 C, relative humidity of 100% and pressure of 4.033 atm from the lower portion of the evaporating tower up to the upper portion. The heated, vapor-loaded air 14 at a temperature of 198 C and relative humidity of 32.3% containing 2,471.2 kg/min. of ethylbenzene vapor from fan 12 may be cooled by 3,800.3 kg/min. of ethylbenzene 18 at 82.1 C from nozzles 21 and by 3,039.7 kg/min. of ethyl-benzene 18′ at 51.8 C from nozzles 21′ and re-circulated. The 438.6 kg/min. of water vapor which has condensed below 154.8 C may be received in receptacle 22, heat exchanged with the ethylbenzene stream 18 to 57.8 C (not shown), and withdrawn as condensate stream 15. Ethylbenzene collected at the bottom of the condensing tower 4 at 196 C may fed by pump 19′ as stream 18′ to sparger 26 and as stream 18″ to nozzles 10. Unvaporized ethylbenzene 18 from pump 19 will be heated by the heat exchange with the condensate stream 15 from 55.8 C to 82.1 C, and 1,754.4 kg/min. of 59.1% CaCl2 solution 16 will be withdrawn at 55.8 C, 4.033 atm.

Since the additional heat which has to be supplied to heat exchaner 6 is as little as 2,118,681 Btu/hr, when compared to the 57,963,143 Btu/hr required to evaporate 438.6 kg/min. of water, the coefficient of performance would be as high as 27.358. The coefficient of performance is lower than in the previous example due to the fact that the pre-heated solution 5 must be heated from 194 C to 200 C instead of from 196 C to 200 C, but is nevertheless still impressive considering the simple structure of only 3 essentially empty tanks for the pre-heating column 25 (256 m3, 5.576 atm), the evaporating tower 11 (357 m3, 4.033 atm) and the condensing tower 4 (377 m3, 4.033 atm). Heat exchanger 6 can also be implemented using a direct heat transfer between the heating medium and the pre-heated stream 5.

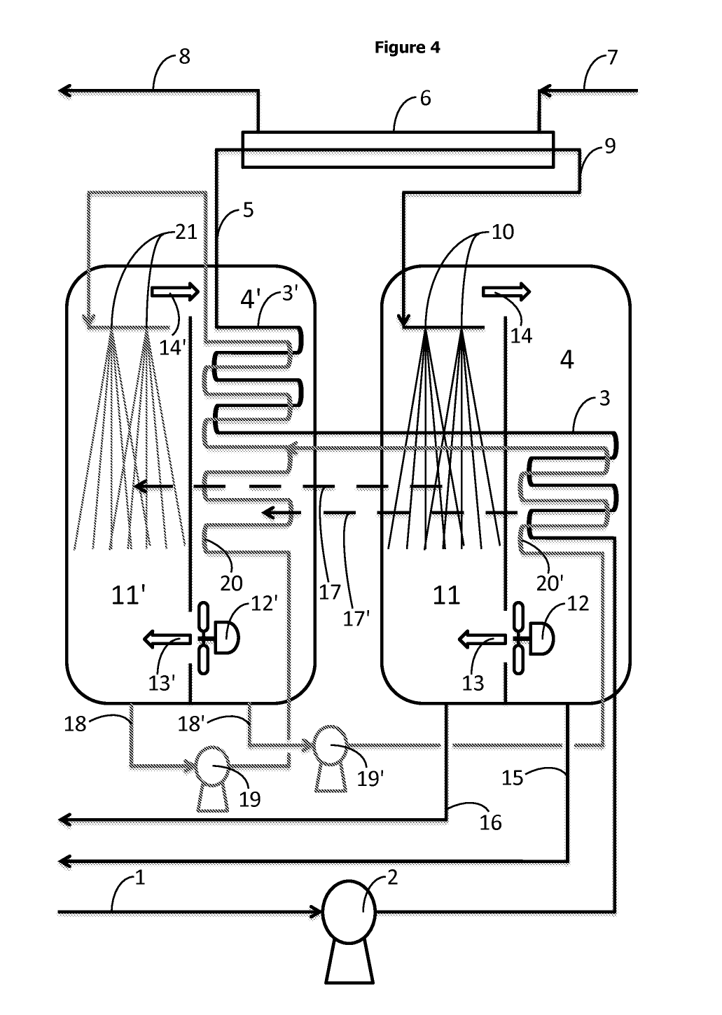

FIG. 4 illustrates a third embodiment wherein the volatile matter is evaporated and condensed in one circuit, while the auxiliary heat transfer fluid is evaporated and condensed in a completely separate circuit. As shown in FIG. 4, feed stream 1 is fed by pump 2 through pre-heating coil 3 in condensing chamber 4 and through pre-heating coil 3′ in condensing chamber 4′ to provide a pre-heated stream 5. The pre-heated stream 5 is then heated in heat exchanger 6 equipped with heating medium inlet 7 and heating medium outlet 8, and the heated stream 9 is sprayed through nozzles 10 into an upper portion of evaporating chamber 11, while fan 12 circulates cooled gas 13 from a lower portion of the evaporating chamber up to the upper portion. The heated, vapor-loaded gas 14 is then passed from an upper portion of the adjacent condensing chamber 4 down over cooling coils 3 and 20′ and the cooled gas is re-circulated by fan 12. Liquid at the bottom of the condensing chamber 4 is directly withdrawn as condensed volatile matter stream 15, and liquid at the bottom of the evaporating chamber 11 is directly withdrawn as concentrated stream 16.

In another circuit, unvaporized heat transfer fluid 18 is fed by pump 19 through heating coil 20 in condensing chamber 4′, while condensed heat transfer fluid 18′ is fed by pump 19′ through heating coil 20′ in condensing chamber 4, then through an upper portion of the heating coil 20, and the combined heat transfer fluid is sprayed through nozzles 21 into an upper portion of evaporating chamber 11′, while fan 12′ circulates cooled gas 13′ from lower portion of the evaporating chamber up to the upper portion. The heated, vapor loaded gas 14′ is then passed from upper portion of the adjacent condensing chamber 4′ down over cooling coils 3′ and 20, and the cooled gas 13′ is recirculated by fan 12′. Since in this arrangement, there will be heat energy imbalances, some heat must be transferred between the chambers as indicated by dashed arrows 17 and 17′, but the actual transfer directions and magnitudes will vary from case to case.

For example, 7,241.7 kg/min. of 61.4% LiBr solution 1 at 40.0 C may be fed by pump 2 and heated in pre-heating coil 3 in condensing chamber 4 to 120.5 C, then in pre-heating coil 3′ in condensing chamber 4′ to 196 C. The pre-heated stream 5 may be heated in heat exchanger 6 to 200 C, 2.756 atm, and the heated stream 9 sprayed through nozzles 10 into the upper portion of evaporating chamber 11, while fan 12 circulates 4,421.2 ft3/min. of cooled air 13 at 42.0 C, 1 atm from lower portion of the evaporating chamber up to the upper portion. The heated, vapor-loaded air 14 at a temperature of 198 C, relative humidity of 11.45% may be passed down over cooling coils 3 and 20′, and the cooled air re-circulated by fan 12. 804.6 kg/min. of condensate 15 may be withdrawn from the bottom of condensing chamber 4 at 42.0 C, while 6,437.1 kg/min. of 69.1% LiBr solution 16 is withdrawn from the bottom of evaporating chamber 11 at 44.0 C.

In another circuit, 3,256.4 kg/min. of unvaporized water 18 at 44.0 C may be fed by pump 19 through heating coil 20 in condensing chamber 4′, 1,184.6 kg/min. of condensed water 18′ at 42.0 C may be fed by pump 19′ through heating coil 20′ in condensing chamber 4, then through the upper portion of heating coil 20, and 4,441.0 kg/min. of combined water at 196 C, 14.231 atm may be sprayed through nozzles 21 into the upper portion of evaporating chamber 11′ to heat 409.1 ft3/min. of cooled air 13′ at 42.0 C, 14.231 atm from fan 12′ to 196 C, relative humidity 100%. The heated, vapor-loaded air 14′ may then be passed down over cooling coils 3′ and 20, and the cooled air re-circulated by fan 12′.

In this case, 39,379,612 Btu/hr must be transferred from evaporating chamber 11 to evaporating chamber 11′ as indicated by dashed arrow 17, and 15,867,326 Btu/hr from condensing chamber 4 to condensing chamber 4′ as indicated by dashed arrow 17′. These heat transfers may be effected either by using heat pipes (which is more flexible) or by re-arranging the auxiliary heat transfer fluid flows to correspond to each particular situation.

Since the additional heat which has to be supplied to heat exchaner 6 is as little as 4,273,843 Btu/hr, when compared to the 106,339,596 Btu/hr required to evaporate 804.6 kg/min. of water, the coefficient of performance would be as high as 24.881. The coefficient of performance is lower than in the first example due to the fact that the flow rate of dilute solution 1 must be doubled to prevent the concentrated solution 16 from solidifying at 44.0 C, but is nevertheless still impressive considering that the condensation of the auxiliary heat transfer fluid must heat the dilute solution 1 from 120.5 C to 196 C instead of from 154.8 C to 194 C. In fact, this arrangement allows the use of any auxiliary heat transfer fluid having sufficiently high critical temperature, particularly those having fairly high heat of condensations. Any convenient operating pressure can also be used. 1 atm has been selected for the evaporating chamber 11/condensing chamber 4 to minimize the construction cost, and 14.231 atm have been selected for the evaporating chamber 11′/condensing chamber 4 to minimize the heat transfer fluid pumping energy. If desired, the heating coils can be replaced by direct heat transfers as exemplified by the pre-heating column 25 in FIG. 3.

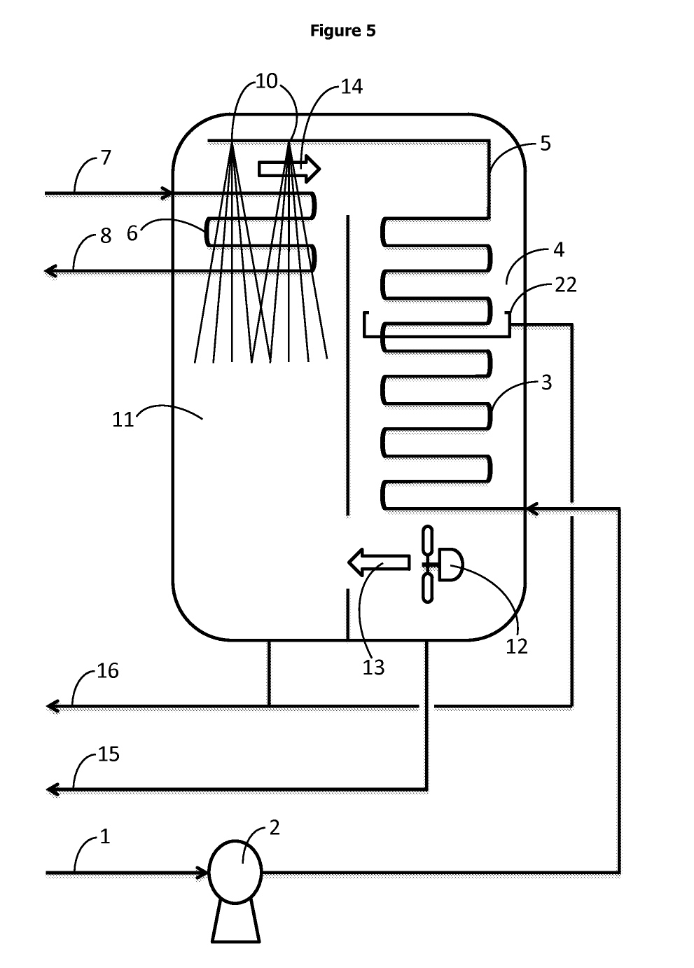

In certain circumstances, the feed stream may contain a relatively small amount of volatile matter, the volatile matter may have a relatively low heat of evaporation, or both, the cooling of the heated stream having a relatively high temperature within the evaporating chamber may generate more heat than that which the vapor is able to carry from the evaporating chamber to the condensing chamber, and it may be desirable to use the auxiliary heat transfer fluid to transfer the excess heat from the evaporating chamber to the condensing chamber as well as to raise the temperature of the pre-heated stream, but the auxiliary heat transfer fluid itself may be difficult to separate from the condensed volatile matter stream. FIG. 5 has shown an embodiment wherein the condensed auxiliary heat transfer fluid is separated off before the 10 volatile matter begin to condense.

For example, 1,785.3 kg/min. of a rich solution 1 having an NH3 concentration of 21.6%, a temperature of 40 C, and a pressure of 1.87 atm may be fed by pump 2 through pre-heating coil 3 in condensing chamber 4, and the pre-heated solution 5 having a temperature of 146 C may be sprayed through nozzles 10 over heat exchanger 6 in an upper portion of evaporating chamber 11, while a heating medium having a temperature of 150 C is fed through inlet 7 and outlet 8. 534.4 ft3/min. of cooled air 13 having a temperature of 42 C, relative humidity of 100% and pressure of 80.3 atm from fan 12 may be heated to 148 C, evaporating 386.4 kg/min. of NH3 and 138.8 kg/min. of water from the solution. Eventhough only 19,126,517 Btu/hr (51.04%) will be taken up in the evaporation of NH3, the evaporation of water will take up a further 18,346,906 Btu/hr (48.96%), enabling the rich solution to be pre-heated to 146 C and reducing the additional heat which has to be supplied to heat exchanger 6 to only 1,808,653 Btu/hr. When compared to the 19,126,517 Btu/hr required to evaporate 385.3 kg/min. of NH3, the coefficient of performance would be 10.575. The coefficient of performance is lower than in the other examples due to the fact that the evaporation of water has taken up nearly half of the available heat.

Eventhough the NH3 vapor in the heated air 14 has a concentration of only 73.6% compared to the amount of water vapor and will not condense down to 104.1 C at 80.3 atm, since substantially all of the water vapor will condense above about 143.0 C at the same pressure, the temperature of the pre-heated solution 5 would be raised to 146 C, and a separator 22 could be used to receive the condensed water vapor. Thus, 386.4 kg/min. of liquefied NH3 15 leaving the bottom of the condensing chamber 4 at 42 C would be essentially pure NH3. The 138.8 kg/min. of condensed water from the receptacle 22 may be further cooled down by a heat exchange with the rich solution (not shown), then combined with 1,260.1 kg/min. of unvaporized water at 44 C from the bottom of the evaporating chamber into 1,398.9 kg/min. of lean solution 16 having an NH3 concentration of essentially 0% and temperature of 43.8 C. Since the receptacle 22 can be positioned anywhere within the 143.0-104.1 temperature range, it can be seen that a rectification function has been provided by a relatively simple arrangement in lui of the typical, elaborate NH3 fractionation column.

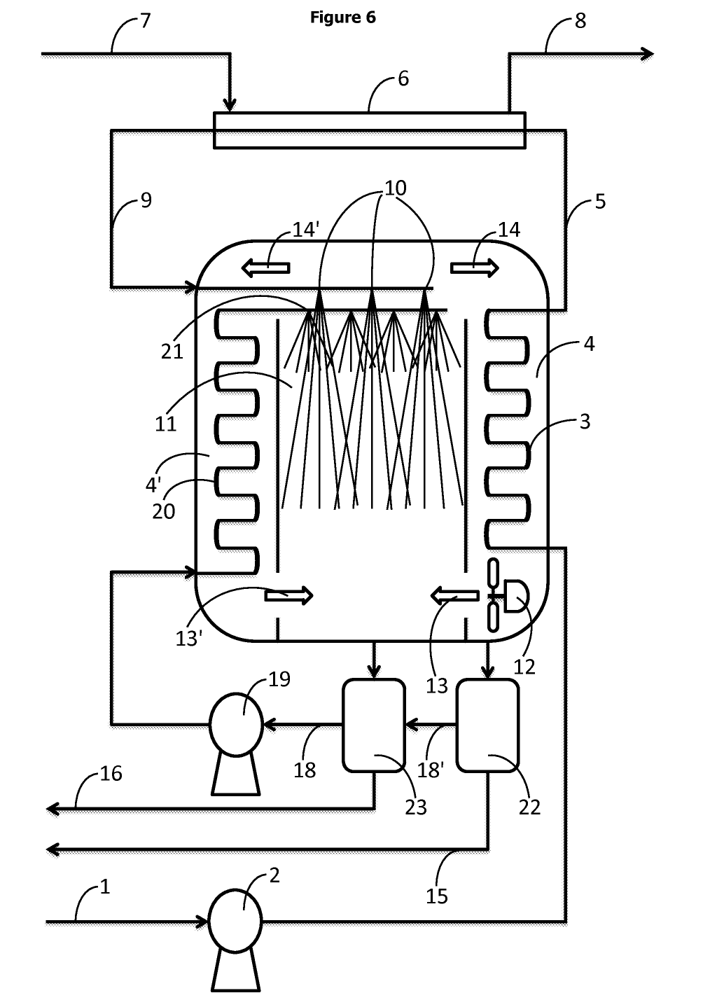

On the other hand, when the feed stream contains overwhelmingly large amount of volatile matter, or the volatile matter has a relatively high heat of evaporation, or both, and the cooling of the heated stream within the evaporating chamber is not able to generate enough heat for the evaporation, the auxiliary heat transfer fluid may be used to transfer heat from the condensing chamber to the evaporating chamber without substantial evaporation. FIG. 6 shows an embodiment wherein the evaporation of the auxiliary heat transfer fluid into the gaseous medium has been inhibited, but the fluid is rather used to transfer a part of the heat of condensation from the condensing chamber to the evaporating chamber instead. (Please, note the similarity between FIG. 6 and FIG. 2.)

For example, 166.67 kg/min. of a vegetable oil in n-hexane solution 1 having an oil concentration of 10% and a temperature of 60 C may be fed by pump 2 through pre-heating coil 3 in condensing chamber 4, the pre-heated solution 5 may be further heated in heat exchanger 6 from 244 C to 250 C, 34.64 atm, and the heated solution 9 may be sprayed through nozzles 10 into the upper portion of evaporating chamber 11 to heat 0.414 ft3/min. of cooled air 13 having a temperature of 63 C and pressure of 33.30 atm from fan 12 to 247 C and evaporate 150 kg/min. of n-hexane from the solution. Since the evaporation of the n-hexane will require 2,362,655 Btu/hr, 100.84 kg/min. of 63.6% LiBr solution 18 at a temperature of 65.8 C may also be fed by pump 19 through heating coil 20 in condensing chamber 4′ and sprayed through nozzles 21 into the upper portion of the evaporating chamber. While the cooling of the vegetable oil in the evaporating chamber from 247 C to 66 C will provide only 468,607 Btu/hr, the cooling of the LiBr solution from 244 C to 66 C will provide 2,498,533 Btu/hr, and the surplus heat of 604,485 Btu/hr will be used to evaporate 4.50 kg/min. of water from the solution. In the absence of the desiccant, much more water would have been evaporated, drastically reducing the heat available for the evaporation of the n-hexane.

Since the additional heat which has to be supplied to the heat exchanger 6 is only 143,992 Btu/hr, when compared to the heat of evaporation of 2,362,655 Btu/hr, the coefficient of performance would be as high as 16.408.

150 kg/min. of condensed n-hexane 15 may be decanted from 4.50 kg/min. of condensed water 18′ in separator 22 and withdrawn at 63 C, 16.67 kg/min. (1 ton/hr) of vegetable oil 16 may be decanted from 96.34 kg/min. of 66.5% LiBr solution in separator 23 and withdrawn at 66 C, and the condensed water 18′ and the somewhat concentrated LiBr solution may be recombined into LiBr solution 18. In this case, even-though the vegetable oil itself could be recycled as auxiliary heat transfer fluid instead of the LiBr solution 18, after having been subjected to high temperatures for several cycles, its quality would probably deteriorate.

The evaporating chamber 11 in all of the above drawings could be a packed or a trayed column. The circulation of the gaseous medium between the condensing chambers 4, 4′ and the evaporating chamber 11 could be effected by natural convection instead of by fan 12. Furthermore, a part or all of the cooled gaseous mediums 13, 13′ could be heat exchanged, bled off, and replaced by fresh gaseous mediums. For example, drier outside air would tend to cool the concentrated solution down more than recycled wet air. Those skilled in the art would readily appreciate that numerous modifications can still be made within the spirit and the scope of the present invention.

### BEST MODES FOR CARRYING OUT THE INVENTION

Same as described with respect to the embodiments shown in FIGS. 2-6.

1. A devolatilization/solution concentration process, said process comprises (a) pre-heating a feed stream from a 1st temperature to a 2nd temperature, (b) providing a small amount of additional heat to the pre-heated stream, (c) evaporating a portion of the heated stream into a gaseous medium to heat the gaseous medium to a 3rd temperature and cool the remaining, concentrated stream to a 4th temperature, (d) condensing the vapor in the gaseous medium from step (c) to provide at least a part of said pre-heating in step (a) and produce a condensed volatile matter stream, and (e) evaporating at least a portion of an auxiliary heat transfer fluid into a gaseous medium and condensing its vapor in the gaseous medium to provide at least another part of said pre-heating in step (a), whereby said 2nd temperature is raised to a point just slightly lower than said 3rd temperature.

2. A devolatilization/solution concentration process according to claim 1, wherein said feed stream comprises a dilute aqueous solution containing a dissolved desiccant.

3. A devolatilization/solution concentration process according to claim 1, wherein said portion of said heated stream and said portion of said auxiliary heat transfer fluid are evaporated into the same gaseous medium.

4. A devolatilization/solution concentration process according to claim 3, wherein said auxiliary heat transfer fluid is immiscible with the condensed volatile matter stream and immiscible the concentrated stream such that it can be readily separated therefrom.
